(19) United States
(12) Patent Application Publication
(10) Pub. No.: US 2017/0286398 A1
(43) Pub. Date: Oct. 5, 2017

(54) METHOD TO RESOLVE THE MEANING OF A BODY OF NATURAL LANGUAGE TEXT USING ARTIFICIAL INTELLIGENCE ANALYSIS IN COMBINATION WITH SEMANTIC AND CONTEXTUAL ANALYSIS

(71) Applicants: Geoffrey Hodgson Hunt, San Francisco, CA (US); Michael Allen Bennett, Cumming, GA (US); James Noel Carboni, Boca Raton, FL (US); Georges Pierre Pantanelli, Houston, TX (US)

(72) Inventors: Geoffrey Hodgson Hunt, San Francisco, CA (US); Michael Allen Bennett, Cumming, GA (US); James Noel Carboni, Boca Raton, FL (US); Georges Pierre Pantanelli, Houston, TX (US)

(21) Appl. No.: 15/084,450

(22) Filed: Mar. 29, 2016

(51) Int. Cl. G06F 17/27; G06N 3/08; G10L 25/30

(52) U.S. Cl. CPC G06F 17/2785; G10L 25/30; G06F 17/2705; G06F 17/2735; G06F 17/2795; G06N 3/08

(57) ABSTRACT

A method of language processing using a primary contextual and semantic analysis with reference to Rich dictionaries (created by combining dictionaries, thesauri, and language and jargon awareness databases) and with reference to connotation databases and contextual connotation databases to perform a full parsing of the text into parts of speech. If connotational or contextual ambiguities remain after this primary analysis is completed, a secondary artificial intelligence analysis module uses the primary analysis output as part of its input to modify some parameters and values within this artificial intelligence module. This module processes iteratively until any ambiguities are resolved. After primary and secondary analyses have taken place, a ranking matrix processor module processes all information acquired by the preceding modules to output a ranking matrix which encapsulates the meaning of the text in a form that may be readily used by machines or 3^{rd} parties to react to the meaning of the text. Specialized Rich dictionaries can be created for use with this method to achieve specific goals, for cross-language translations, or to compare translations in different languages to detect inconsistencies.

### FIELD OF THE INVENTION

The embodiments of this invention generally relate to a system and method of natural language processing and inter-language processing using text parsing with contextual, semantic and artificial intelligence analysis in combination with reference dictionaries to generate contextual indices and contextual matrices.

Where ambiguity remains after contextual and semantic analysis, this method integrates an artificial intelligence analysis module to fully resolve ambiguities, appending the resultant contextual matrices. These contextual matrices are compared to contextual matrices from other text parsing matrices and/or to reference contextual matrices to generate correlation matrices and ranking reports that encapsulate the essential meaning of the body of text in a form that can be readily understood and used by humans or machines.

### BACKGROUND

Analysis of the meaning of text is used extensively by organizations reliant on automated communications, including (but not limited to) advertisers, advertising networks, social networks, corporate oversight groups, intelligence agencies, etc. These organizations desire to understand the intent, overt sentiment, and/or veiled sentiment of the author of the text for many reasons, including (but not limited to): distributing the text to relevant readers, serving advertisements that have some connection to the interests embodied in the text, filtering based on concepts or sentiments that might be of interest, etc.

### DETAILED DESCRIPTION

Our method of natural language processing (NLP) first analyzes any sample text using contextual and semantic analysis in combination with one or more Rich dictionaries to generate parsed text fragments and then word connotations and contextual parsed text fragment connotations from those parsed text fragments.

A Rich dictionary is created for each language by combining specific dictionaries, thesauri, and language and jargon awareness databases into tables. Matrix elements in these tables include data such as synonyms, antonyms, connotations (see FIGS. 2 and 4), and scaled ranking indices of information such as moment in time (verb tense and word usage—see FIGS. 2 and 3), priority (see FIG. 4) and sentiment (see FIG. 5). Indices are formatted as matrix elements in the tables. For specific applications of our method, these matrix element values may be tuned to emphasize or create specialized connections between words or phrases. For the application of our method between languages the matrix elements may contain cross-language interlinked indices.

A secondary module using artificial intelligence is potentially implemented. In our method for natural language analysis, some parameters and values have been preset within this module for natural language application. This module is invoked if the semantic and contextual analysis modules fail to resolve all ambiguities in the generated parsed text fragments (see FIGS. 9 and 10). In this case, the output from the semantic and contextual analysis modules is used as input to the artificial intelligence module. The artificial intelligence module then processes iteratively, modifying, or appending the original parameters until the ambiguity is resolved.

A contextual connotation matrix is then generated and matrix element values are assigned for each parsed text fragment. The contextual connotation matrix element values are then referenced against stored connotation database tables and contextual connotation database tables to generate a correlation matrix.

The correlation matrix produced using the output from the contextual, semantic, and artificial intelligence analyses is then used as input to the ranking matrix processor module, which processes all the information acquired by the preceding modules to output a ranking matrix which encapsulates the meaning of the original text in a form that may be readily used by machines or humans.

The matrix element values representing each word connotation or contextual parsed text fragment connotation are generated without reference to any specific single language, so these matrix element values can also be referenced against cross-language interlinked indices to provide understanding of a text's meaning across language barriers.

To simplify the description of how our method works, we have limited the figures below to only using matrix elements. Those skilled in the art will recognize that any mathematical sets with objects that are distinct and allow binary and/or logic operations could be used, including but not limited to: vectors, hyper-matrices and tensors in n-dimensional spaces.

FIG. 1 shows a diagram of the contextual text parsing analysis to generate several correlation matrices. A user's text 100 is analyzed with the matrix generation module 101 using information compiled in the Rich dictionary 102. The word connotation module 103 and contextual text connotation module 104 are activated to generate the text parsing 105. Several parsed text fragments are identified and created, respectively “element 1” 106 with “parsed text fragment ranking values” 107 and “parsed text fragment matrix indices for each element M1” 108, then “element 2” 109 with “parsed text fragment ranking values” 110 and “parsed text fragment matrix indices for each element M2” 111, and “element n” 112 with “parsed text fragment ranking values” 113 and “parsed text fragment matrix indices for each element Mn” 114.

The parsed text fragment ranking values 107 from “element 1” 106 are compared to the parsed text fragment ranking values 110 from “element 2” 109 to generate a “correlation matrix 1” 120. From contextual text ranking (1,2) 121, connotations indices 122, words and contextual connotations delta indices 125 respectively for words 126 and contextual correlation 127 are computed. These delta indices are used to build the correlation matrix elements 128 and thereafter to generate the text priority Interest 129.

The parsed text fragment ranking values from “element 2” 109 are compared to the parsed text fragment ranking values from “element n” 112 to generate a “correlation matrix n” 130. From contextual text ranking (2,n) 131, words and contextual connotations delta indices 135 respectively for words 136 and contextual correlation 137 are computed. These delta indices are used to build the correlation matrix elements 138 and thereafter to generate the text priority interest 139.

The invention is not limited to this example; those skilled in the state of the art will recognize that the invention is applicable to compare more than two elements within the author's text to generate several correlation matrices. Also, those skilled in the state of the art will recognize that the invention is not limited to the English example but is applicable to any connotations, verb tenses, languages, and regional dialects.

FIG. 2 is a block diagram illustrating how one embodiment of the invention is implemented with an author's text “We saw a good film last week and we will be going to the theater Saturday” 200.

Fragments of corresponding matrix elements indices from our Rich dictionary for a given language (x) 201 are shown 205 with the word connotation “Entertainment” 210 with level-2 connotations respectively for “Cinema” 211 and its ranking indices “21,1”,“Theater “212” and its ranking indices “21,2” and “opera” 213 and its ranking indices 21,3.

Also shown are the text contextual connotation “verb tenses” 215 and level-2 connotations respectively for “Simple past” 220 and its contextual ranking indices “31,−1,−1” 221 and for “Future continuous” 222 and its ranking indices “31,2,3” 223. Since verb tenses are moment-in-time related, the contextual connotation indices are scalable ascending and descending indices values.

Using our connotations dictionaries the ranking word value will be extracted 250 to generate the correlation matrix elements using our text parsing module (NLP) with contextual, semantic, and artificial intelligence analysis 230. Word connotations elements and contextual connotations elements are identified for each parsed text fragment 255. For parsed text fragment 1 “We saw a good film last week” 260 the word connotation value is for “Cinema=a,1” 251 and the verb tense contextual connotation value is “Simple past=b,2;1” 253. The elements of the M×1 matrix 260 are generated with these word connotation and contextual connotation values. In parsed text fragment 2 “we will be going to the theater Saturday” 270 the word connotation value assigned is for “theater=a.2” 252 and a contextual connotation value “Future continuous=b,3;3” 254 is assigned from verb tenses. The values of the elements of M×2 matrix 270 are generated with these word connotation and contextual connotation values.

The elements of correlation matrix M are generated using the contextual correlation matrix generation module 290. To create the elements of the correlation matrix M (correlation) 291, the elements of matrix “M×2((a,2),(b,3,3))” 292 is compared to the elements of matrix “M×1((a,1),(b,2,1))” 293 using the contextual text correlation and ranking module 294. From this comparison, the author's intent and priority are extracted “going to theater” 295. Those skilled in the state of the art will recognize that the invention is not limited to the verb tenses and to the word connotations shown and that any scalable words could be ranked with gradient indices values. Also, it is applicable to many languages, combinations, or variations that exist or will exist. Furthermore, it is not limited to analysis of a single sentence with two parsed text fragments and comparisons but could be extended to multiple sentences with multiple parsed text fragments.

Those skilled in the state of the art will also recognize that in our method “matrix” and “tensors” are synonyms.

FIG. 3 is a block diagram illustrating how one embodiment of the invention is implemented. It shows how the correlation matrix elements are generated using the same author's text as in the FIG. 2 “We saw a good film last week and we will be going to the theater Saturday” 300 to extract an author's intent or priority.

The necessary elements required is indicated in 301 for each parsed text fragment which had been identified using the text parsing module. For each parsed text fragment 302 a correlation matrix is created. To build these matrices mathematical indices 303 for word connotation and contextual connotation have been identified to form the elements of the matrices 304 which will be compared 305.

Respectively for parsed text fragment 1 “we saw a good film last week” 311 “a(21)=1” 312 while “b(31)=−1 and −1” 313 with M1 elements to be (21,1; 31,−1,−1) 314; parsed text fragment 2 “we will be going to the theater Saturday” 315, “a(21)=2” 312 while “b(31)=2 and 3” 313 with M2 elements to be (21,2;31,2,3) 316.

The indices values 320 for each element are shown respectively for “M1 with aₓ=21 and a_{y}=1 while bx=31, b_{y}=−1 and b_{z}=−1” 321 and “M2 with aₓ=21 and a_{y}=2 while bₓ=31, b_{y}=2 and b_{z}=3” 322.

Our method uses a contextual text correlation and ranking matrix module 323 thereafter to compare all and each element of the matrices M1 to those of M2. The delta b's indices are time scalable continuous indexes 324; therefore, our module will generate respectively the following indices values “0, +3, +4”, with indices sum of +3+4=7 which is larger than 1 and therefore showing M2 has contextual connotation primary text interest and priority “going to ” 325. The delta a's indices 326 are simple word connotations and along with contextual connotation association will generate “theater” 327. This leads to the generation of the author's sentiment and priority Interest 328 “going to theater” 329. The invention is not limited to the above example which uses integers for indices and algebraic computations to generate the user's sentiment and priority interest. Those skilled in the state of the art will recognize that the invention is not limited to integers but is applicable to computable real numbers and any mathematical sets with objects that are distinct, allowing logic operations. Also, those skilled in the state of the art will recognize that the invention is not limited to matrix (n * vectors), but could be used for vectors, hyper-matrix and tensors in n-dimensional spaces. Also, it is not limited to English, but is applicable to other languages, dialects, acronyms.

FIG. 4 is a block diagram illustrating how one embodiment of the invention is implemented for a different text. It shows how the correlation matrix elements are generated using an author's text “A park bench is comfortable, a restaurant chair is more comfortable, but a sofa is the most comfortable” 400 is analyzed.

Fragments from the corresponding tables from our Rich dictionary are shown 405 with the needed word connotation “Furniture” 410 with level-2 connotations respectively for “Sitting” 411 with its ranking indices “40,1” 415. While the text contextual connotation “comparative, superlative” 420 and level-2 connotations respectively for “None” 421 with its contextual ranking indices “70,1” 425, for “Comparative” 422 and its ranking indices “70,2” 426 and for “Superlative” 423 with its contextual ranking indices “70,3” 427. Since “comparative superlative” has an escalating concept, the contextual connotation indices are scalable, assigning increasing values with the comparative to superlative concept. Using our connotations dictionaries the ranking word values will be extracted 450 to generate the correlation Matrix. Using the text parsing module (NLP) with contextual, semantic and artificial intelligence Analysis 451 each connotation is identified 452, 453, 454, 455. For parsed text fragment 1 “a park bench is comfortable” 460 the word connotation value is for “Sitting=d,1” 452 and the contextual connotation value is “None=c,1” 453. The elements of the Me1 matrix 460 are generated with the word connotation and the contextual connotation values. Whereas for parsed text fragment 2 “a restaurant chair is more comfortable” 470 the word connotation value is for “Sitting=d,1” 452 and the contextual connotation value is “Comparative=c,2” 454. The elements of the Me2 matrix 470 are generated with the word connotation and the contextual connotation values.

And for parsed text fragment 3 “a sofa is the most comfortable” 480 the word connotation value is for “Sitting=d,1” 452 and the contextual connotation value is “Superlative=c,3” 455. The elements of the ranking Me3 matrix 480 are generated with the word connotation and the contextual connotation values.

The Correlation Matrix is generated 491 using the correlation matrix generation module 490. To create the correlation matrix M(correlation) 491, the matrix “Me3((d,1),(c,3))” 492 is compared to the matrix “Me2((d,1),(c,2,))” 493 and to the matrix “Me1 ((d,1),(c,1))” 494. From this comparison and using the contextual text correlation and ranking module 495, the author's intent and priority are extracted “Most comfortable sofa” 496.

The invention is not limited to the above simple example. Those skilled in the state of the art will recognize that the invention is not limited to this concept and to the word connotations shown, and that any scalable words and concepts could be ranked with gradient indices values. Also, it is not limited to English, but is applicable to other languages, dialects, acronyms and across languages. Furthermore, it is not limited to analysis of a single sentence with two subsets parsed text fragments and comparisons but could be extended to multiple parsed text fragments.

FIG. 5 is a block diagram illustrating how one embodiment of the invention is implemented. How the correlation matrix elements are generated using the same author's text as in FIG. 4 “A park bench is comfortable, a restaurant chair is more comfortable, but a sofa is the most comfortable” 500 to extract the author's intent or priority. This different text shows how different priorities are solved using our method.

It shows in detail each matrix elements ranking indices values. The necessary elements required are indicated in 501 for each parsed text fragment which has been identified using the text parsing module. A correlation matrix will be created 504 for all parsed text fragments 502. To build these matrices mathematical indices 503 for word connotation and contextual connotation have been identified to form the elements of the matrices 504 which will be compared 505.

Respectively for parsed text fragment 1 “A park bench is comfortable” 510 “d(40)=1” 513 while “c(70)=1” 514 with M1 elements to be (40,1; 70, 1) 515; parsed text fragment 2 “a restaurant chair is more comfortable” 511, “d(40)=1” 513 while “c(70)=2” 514 with M2 elements to be (40,1;70,2) 516 whereas parsed text fragment 3 “a sofa is the most comfortable” 511, “d(40)=1” 513 while “c(70)=3” 514 with M3 elements to be (40,1;70,3) 517.

The indices values 520 for each element are shown respectively for “M1 with dx=40 and d_{y}=1 while cx=70 and c_{y}=1” 521 and “M2 with dx=40 and d_{y}=1 while cx=70 and cy=2” 522 while “M3 dₓ=40 and d_{y}=1 while cx=70 and c_{y}=3” 523.

Our method uses a contextual text correlation and ranking module 524 thereafter to compare all and each elements of the matrices M1 to M2 to M3. The delta c's indices are concept scalable continuous indexes 531; therefore, our module will generate respectively for M3 to M2 the following indices values “0, +1”, as a result showing M3 has for contextual connotation a primary text interest and priority “most” 535. The delta d's indices 532 are simple word connotations and along with contextual connotation association will generate “sofa” 533. This leads to the generation of the author's sentiment and priority Interest “most comfortable sofa” 545.

While the correlation and ranking matrix module will generate respectively for M2 to M1 the following indices values “0, +1”, as a result showing M2 has for contextual connotation a primarily text interest and priority “more” 536. The delta d's indices 532 are simple word connotations and along with contextual connotation association will generate chair 533. This leads to the generation of the author's sentiment and priority interest “more comfortable chair” 546.

Then our module generates respectively for M3 to M1 the following indices values “0, +2”, as a result showing M3 has for contextual connotation a primary text interest and priority “most” 537. The delta d's indices 532 are simple word connotations and along with contextual connotation association will generate “sofa” 533. This leads to the generation of the author's sentiment and priority interest “most comfortable sofa” 547.

Our module will generate respectively for M3 to M2 to M1 the following indices values “0, +2”, as a result showing M3 has for contextual connotation a primary text interest and priority “most” 538. The delta d's indices 532 are simple word connotations and along with contextual connotation association will generate sofa 533. This leads to the generation of the author's sentiment and priority interest “most comfortable sofa” 548.

The invention is not limited to the above example which uses integers for indices and algebraic computations to generate the author's sentiment and priority interest. Those skilled in the state of the art will recognize that the invention is not limited to integers but applicable to computable real numbers and any mathematical sets with objects that are distinct, allowing binary and or logic operations. Also, those skilled in the state of the art will recognize that the invention is not limited to matrix (n*vectors), but could be used for vectors, hyper-matrix and tensors in n-dimensional spaces.

FIG. 6 shows a flow diagram on how the invention analyzes a text 600. The text is analyzed using the natural language analysis module 601 using first the contextual, semantic analysis module 602 to solve ambiguity and parsing 603. Where ambiguity and parsing remains unsolved after contextual and semantic analysis 604, then the method integrates an artificial intelligence analysis module 607 to analyze and to resolve these ambiguities more fully with an iterative back and forth processing 606 to solve ambiguity and parsing 603. Then after having solved ambiguity and parsing this natural language analysis module generates an accurate text analysis 610.

Those skilled in the state of the art will recognize that intermediate or other information might be generated.

FIG. 7 shows a flow diagram how the artificial intelligence analysis module is integrated in the natural language analysis. Initially, a Human linguistic 703 has set some initial parameters and values within the artificial intelligence analysis module 702. A text to be analyzed 700 is first processed by the contextual and semantic analysis module 701. This module output modifies or append 705 those parameters and values within the artificial intelligence analysis module 702. After several iterations, the artificial intelligence analysis module output 706 generates an accurate text analysis 710. It may also modify and append 707 the artificial intelligence analysis module 702.

Those skilled in the state of the art will recognize that any artificial intelligence application and or network could be used. Those skilled in the state of the art will also recognize or ordered values and are not limited to number format.

FIG. 8 shows a flow diagram of how the invention identifies unresolved ambiguity, new or unidentified words, connotations, or anomalous identifications. A text is analyzed 800 with a natural language processing method 801. In this method, the major steps involve respectively Rich dictionary 802, contextual and semantic analysis module 803 and an artificial intelligence analysis module 804 to generate a text analysis 805. When some issue remains, this analysis is processed using a quality assessment classification 806 (which in this case returns a result of wrong and/or poor analysis). When a new or unidentified word or unidentified connotation is found, a Human linguist 807 modifies the Rich dictionary 802. If ambiguity is still not resolved, a Human linguist modifies parameters 808 within the artificial intelligence analysis module 804. Anomalous word usage might indicate that a code is being used in order to convey illicit information. When an anomalous code word or connotation is discovered and identified 810 it is reported and logged 811.

Those skilled in the state of the art will also recognize that the Human process will decrease and progressively be replaced with machine processing.

FIG. 9 shows a block diagram illustrating how the invention processes a text containing words having multiple possible meanings using semantic and contextual analysis. The main steps involved in the process are shown 900. Connotations of the words having only one possible grammatical classification in the text “did you see the lunar eclipse last year” 901 are assigned 902. The natural language processing must resolve an ambiguity- which of the two meanings of “eclipse” is correct in this sentence 903. In this case, the semantic and contextual Module analysis 904 has attributed two possible connotations to “eclipse” 905, “Astronomy” 906 and “automotive” 907. In a similar manner, it has attributed to the word “lunar” 908 one connotation “astronomy” 909. The ambiguity is resolved 910 and only one connotation is displayed for “eclipse”, namely “astronomy” 911. This result is forwarded 912 to the ranking matrix module 913.

Those skilled in the state of the art will recognize that the invention is not limited to the above example with a word with only two connotations to be compared with a word with only one connotation, but can also be applied to text having many words with multiple possible connotations.

FIG. 10 shows a block diagram illustrating how the invention processes a text containing words having multiple possible grammatical classifications using artificial intelligence analysis after the semantic and contextual analysis step has failed to resolve all ambiguities. The main steps involved in the process are shown 1000. The grammatical classification of each word in the text “he runs like a horse” 1001 is analyzed. For each word in this text the possible grammatical classifications are displayed 1002. The natural language processor (NLP) attempts to resolve any connotation ambiguities 1003. The semantic and contextual analysis module 1004 has acquired some information 1005, but has been unable to resolve ambiguity 1006 about the correct part of speech for the word “like”. The processing is transferred to the artificial intelligence analysis module 1007 for analysis. Using the output from the semantic and contextual analysis module, the NLP has formed a specific and dedicated artificial intelligence analysis module. It modifies and appends initial parameters of the artificial intelligence analysis module.1008. These parameters are modified and appended until the ambiguity has been resolved and a proper understanding (or translation if the system is used across different languages) has been reached 1009. The ambiguity is resolved and only the grammatical classification “preposition” is displayed for “like” 1010. This result is forwarded 1011 to the ranking matrix module 1012.

Those skilled in the state of the art will recognize that the invention is not limited to the above example with only one word with only several grammatical classifications to be compared with words with only one grammatical classification, but can also be applied to text containing many words with multiple possible connotations.

Those skilled in the state of the art will recognize that the invention is not limited to the above example concerning ambiguity with regard to grammatical parts of speech, but rather that artificial intelligence can be used to resolve ambiguities of other types as well, including (but not limited to) context and translation between languages.

Those skilled in the state of the art will recognize that an artificial intelligence analysis module may be assigned initial parameters values based on outputs from other steps or sources besides a semantic and contextual analysis as in this example.

Those skilled in the state of the art will recognize that an artificial intelligence analysis module could be any network such as Bayesian.

Those skilled in the state of the art will recognize that some artificial intelligence analysis module may be assigned pre-set parameters as analyzed for a linguistic family group (e.g. Romance, Germanic, and Slavic language groups).

FIG. 11 shows a block diagram illustrating how the invention processes a text using artificial intelligence analysis module after the semantic and contextual analysis step has failed to resolve a proper text understanding. A sentence 1100 is analyzed by the artificial intelligence module for parsing 1101 into three parsing texts 1102.

In the French sentence “les deux jolis chats blancs courent vite”; “les deux” 1110 is found to be a combination of a definite article “les” 1111 and a numeral adjective “deux” 1112 to form the sentence determinant. The next parsing text “jolis chats blancs” 1120 is a combination of “jolis” 1122 a qualitative adjective, “chats” a noun 1123; and again, a qualitative adjective “blancs” 1124, the last parsing “courent vite” 1030 form a verbal group with “courent” a verb 1131 and “vite” an adverb 1132.

The parsing has determined a nominal group 1140 plus a verbal group 1145. To ascertain whether this constitutes a proper understanding of the text a circular translation is performed. Each parsing which had been identified using the artificial intelligence analysis module is consequently translated properly into English: “two pretty white cats run fast” 1150. In the translated sentence “two” is the determinant 1151, “pretty white cats” the nominal group 1152 and “run fast” the verbal group 1153.

The analysis is shown from French to English but will have been conducted in a similar manner from English to French by using the artificial intelligence analysis module. Those skilled in the state of the art will recognize that the invention is not limited to the above example concerning “ambiguity” with regard to a translated parsing matching the original text parsing, but rather that artificial intelligence analysis module can be used to resolve “ambiguities” of other types as well.

Those skilled in the state of the art will recognize that the invention is not limited to the French and English examples but is applicable to any combination of languages.

FIG. 12 shows a flow diagram of how the method verifies and ascertain a quality level using a correlation matrix and translation comparison, and how the system is adjusted. In the following examples, since the method is translating from a language (a) to a language (b), it needs Rich dictionaries for language (a) and language (b) with dedicated interlinked indices between Rich dictionaries language (a) and language (b) 1202, contextual and semantic analysis modules for language (a) and language (b) 1203 with artificial intelligence analysis modules for language (a) and for language (b) 1204. The Original text language (a) 1200 is the input to be analyzed in the natural language processing module 4201 using respectively (as required) Rich dictionary language (a) 1202, contextual and semantic module for language (a) 1203 with artificial intelligence analysis module for Language (a) 1204.

The method uses the correlation matrix generation module for Language (a) 1205 to generate the corresponding Correlation Matrix Elements Language (a) 1210. This set of information is input into both the correlation matrix elements comparison module 1230 and the translation module for language (a) to language (b) 1211, which generates translated text in language (b) 1212.

This translated text language (b) 1212 is then given for a translation study and comparison to a Human translator 1235.

This translated text language (1212) may also be input for analysis in the natural language processing module 1201 using, this time, respectively (as required) the Rich dictionary for Language (b) 1202, contextual and semantic analysis module for (b) 1203 with artificial intelligence analysis for language (b) 1204.

Again, the method uses the correlation matrix generation module for language (b) 1205 to generate the corresponding correlation matrix elements for language (b). 1220. This information is input into both the correlation matrix elements comparison module 1230 and the translation module for language (b) to language (a) module 1222, which generates a new translation text in language (a-t) 1223.

This translation text language (a-t) is also input to be analyzed in the natural Language processing module 1201 and all the necessary and similar steps to generate the corresponding correlation matrix elements language (a-t) 1221 to be input into the correlation matrix elements comparison module 1230 and also given for a translation study and comparison by a Human translator 1235.

All these correlation matrix elements are compared 1230, respectively language (a) to language (b) and language (a) to language (a-t). Note here that all elements of the correlation matrix are independent of the language.

If the result is different, a Human linguistic intervention 1231 is necessary to modify or append the Artificial Intelligence Neural Network 1205.

If the result is identical, the quality of the analysis is ascertained 1232.

### BRIEF DESCRIPTION OF THE DRAWINGS

FIG. 1 shows a diagram of the contextual text parsing analysis to generate several correlation matrixes.

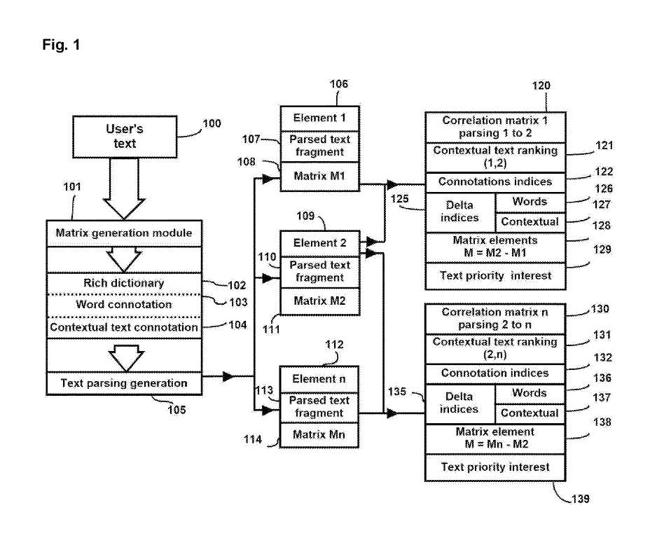

FIG. 2 shows a diagram illustrating how one embodiment of the invention is implemented for a user's text “We saw a good film last week and we will be going to the theater Saturday”.

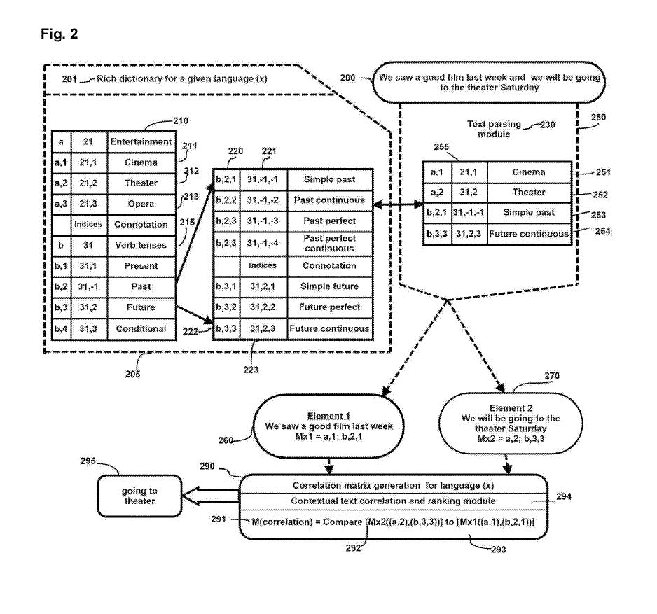

FIG. 3 shows a diagram of how the correlation matrix elements are generated for a user's text “We saw a good film last week and we will be going to the theater Saturday” to correctly generate the author's intent.

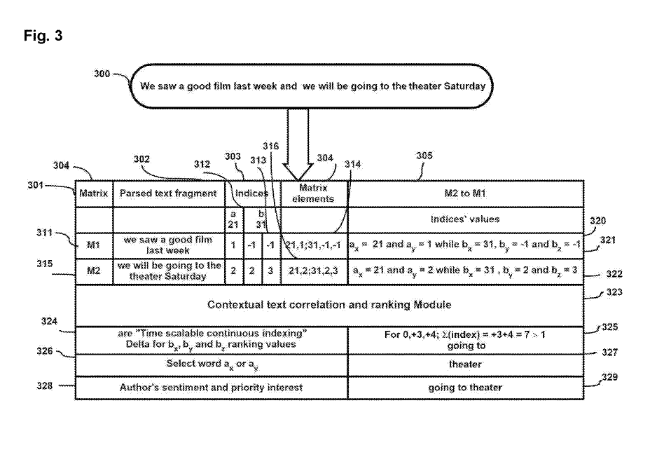

FIG. 4 shows a diagram illustrating how one embodiment of the invention is implemented for a user's text “A park bench is comfortable, a restaurant chair is more comfortable, but a sofa is the most comfortable”

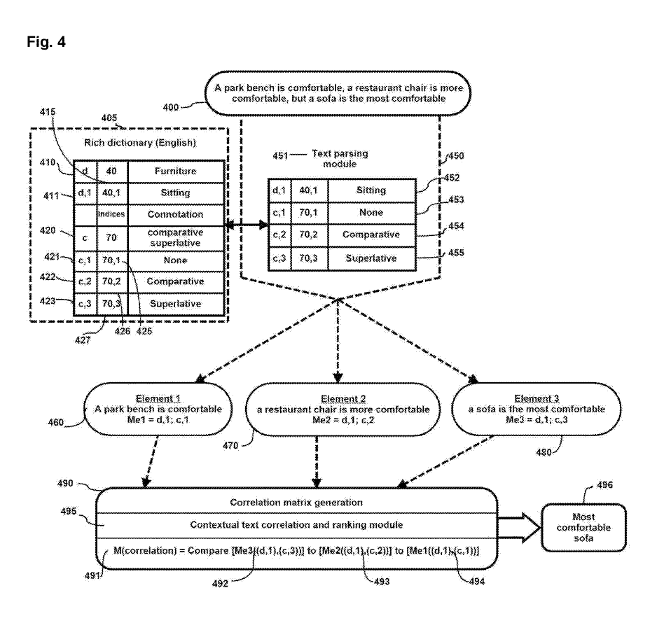

FIG. 5 shows how the correlation matrix elements are generated for a user's text “A park bench is comfortable, a restaurant chair is more comfortable, but a sofa is the most comfortable”.

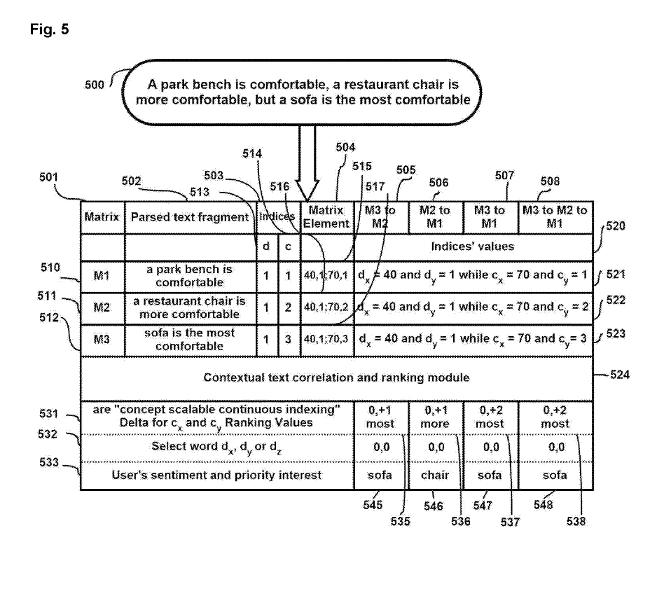

FIG. 6 shows a flow diagram illustrating how the invention analyzes a text using an natural language analysis module.

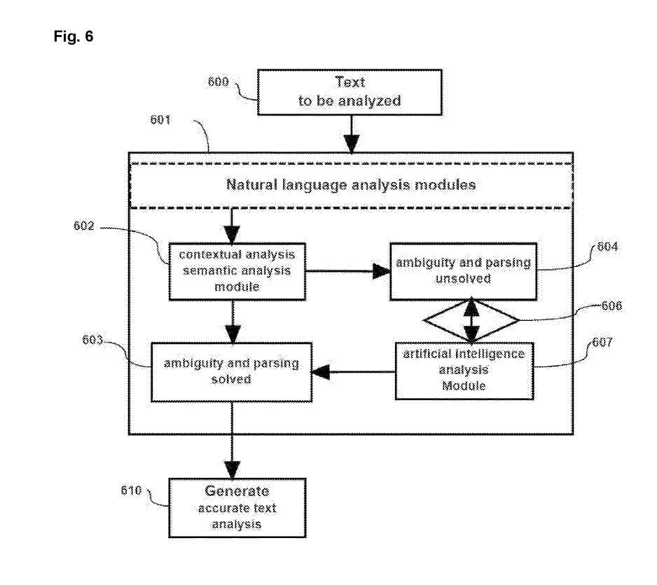

FIG. 7 shows a flow diagram how the artificial intelligence module is integrated in the natural language analysis.

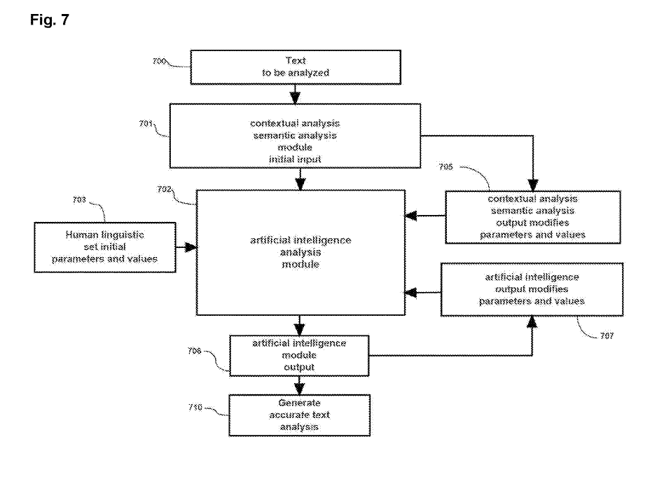

FIG. 8 shows a flow diagram how the invention identifies unresolved ambiguity, new or unidentified words or connotations or anomalous identification.

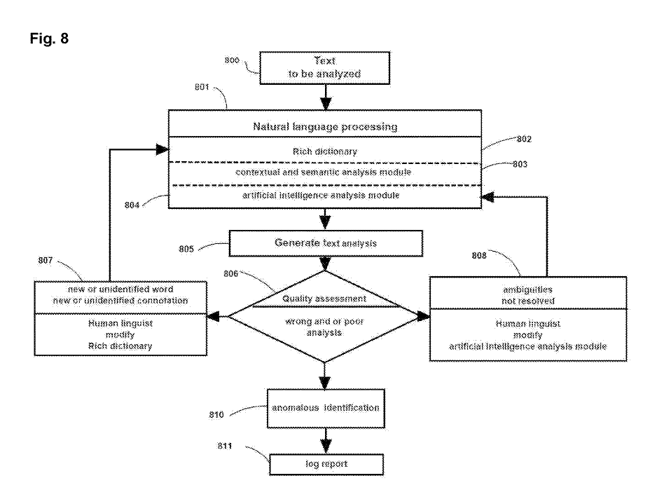

FIG. 9 shows a block diagram illustrating how the invention processes a text containing words with multiples possible meaning using semantic and contextual analysis.

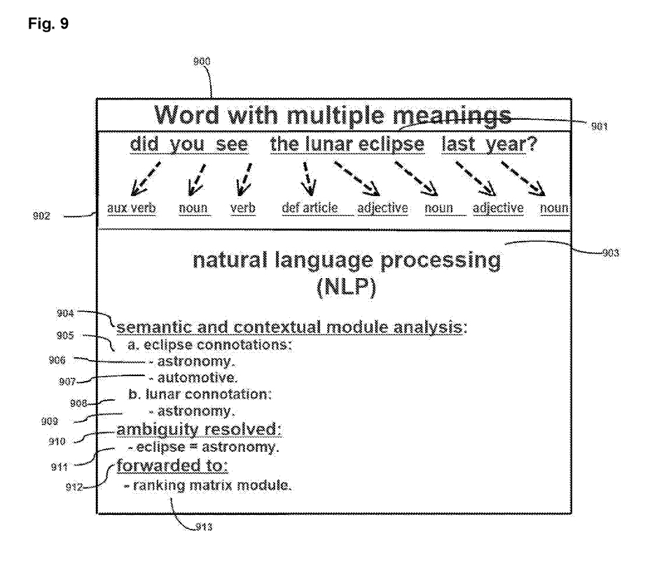

FIG. 10 shows a block diagram illustrating how the invention processes a text containing words with having multiple possible grammatical classifications using an artificial intelligence module analysis.

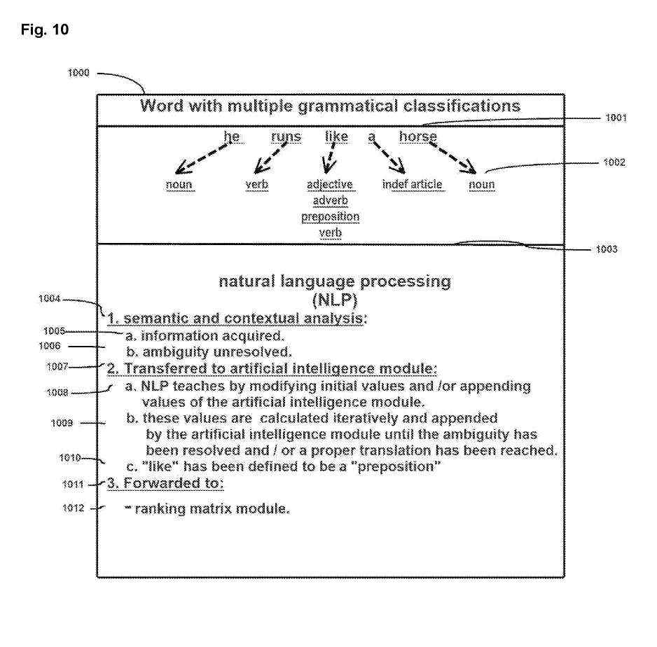

FIG. 11 shows a block diagram illustrating how the invention processes a text using artificial intelligence module after the semantic and contextual analysis step has failed to resolve a proper text understanding.

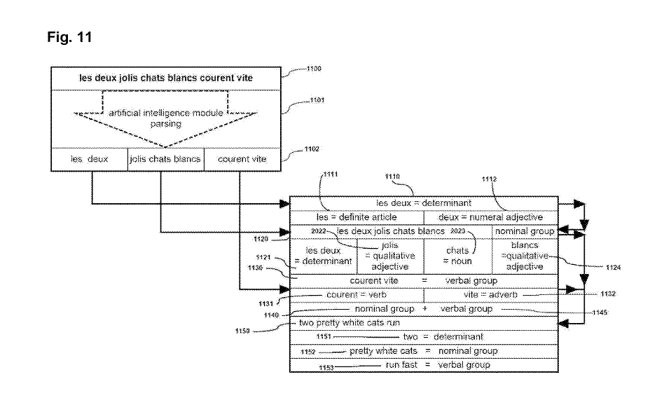

FIG. 12 shows a flow diagram of how the method verifies a high-quality level using a correlation matrix and translation comparison, and how the system is adjusted to improve quality.

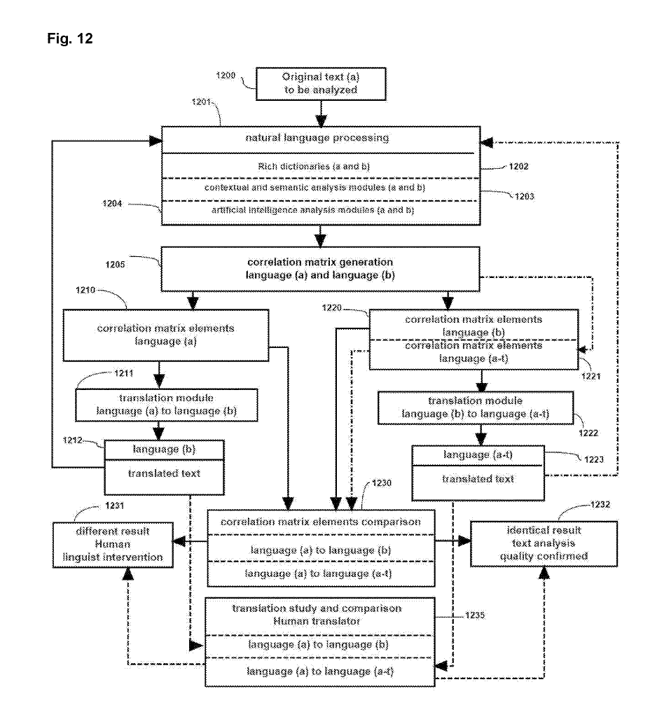

What is claimed is:

1. A method to improve Information flow by using Algorithmic Semantic, Contextual and Artificial Intelligence.

2. The method of claim 1, wherein an Artificial Intelligence Neural Network is integrated into the system.

3. The method of claim 1, wherein a Natural Language Bayesian Network structure is created before using an Artificial Intelligence Neural Network.

4. The method of claim 1, wherein the system teaches an Artificial Intelligence Neural Network using information acquired from Semantic and Contextual Analysis.

5. A method to generate a correlation matrix between text and its parsing to improve information flow.

6. The method of claim 5, wherein Semantic, Contextual and Artificial Intelligence analyses are used to create parsed text fragments.

7. The method of claim 5, wherein language-awareness is used to generate language-independent modules from parsed text fragments.

8. The method of claim 5, wherein texts are ranked on the fly and in real time using their connotation indices and their contextual connotation indices.

9. The method of claim 5, wherein parsing text matrices are ranked and compared on the fly and in real time.

10. The method of claim 5, wherein a user's or author's sentiment within a text is determined and identified on the fly and in real time.

11. The method of claim 5, wherein a user's or author's sentiment between two or more text parsing indices is identified and compared on the fly and in real time.

12. A method to associate unique connotation indices and values with words in thesauri, dictionaries and texts.

13. The method of claim 12, wherein the association is between contextual connotation indices and their values and a text.

14. The method of claim 12, wherein the association is between unique connotation indices and each word connotation within a text.

15. The method of claim 12, comprising the association of opposite contextual connotation indices and values of an antonym with the contextual connotation indices of its synonym.

16. The method of claim 12, as applied to comparing and ranking connotation related indices and values by assigning relative scale values.

17. The method of claim 12, as applied to associating connotation scalable indices and values with verb tenses.

18. The method of claim 12, as applied to associating connotation indices and contextual connotation indices and values with a text.

19. The method of claim 12, as applied to creating parsing text matrices using word connotation and contextual indices and values.
